(19) United States
(12) Patent Application Publication
(10) Pub. No.: US 2026/0210804 A1
(43) Pub. Date: Jul. 23, 2026

(54) VIRTUAL EVALUATION METHOD AND DEVICE FOR ACTUAL ROAD ENERGY CONSUMPTION OF NEW ENERGY VEHICLE

(71) Applicant: CATARC AUTOMOTIVE TEST CENTER (TIANJIN) CO., LTD., TIANJIN (CN)

(72) Inventors: WEI WANG, TIANJIN (CN); TING DONG, TIANJIN (CN); WENBO LI, TIANJIN (CN); FUFAN QU, TIANJIN (CN); QINGYU MENG, TIANJIN (CN); ZHENG MEI, TIANJIN (CN); HONG ZHENG, TIANJIN (CN); PAN SHI, TIANJIN (CN); XIAOHUI ZHANG, TIANJIN (CN); XIN LI, TIANJIN (CN); LIGUANG WU, TIANJIN (CN); CUNYANG SHI, TIANJIN (CN); MAODONG FANG, TIANJIN (CN); WANG GAO, TIANJIN (CN); NAN ZHANG, TIANJIN (CN)

(73) Assignee: CATARC AUTOMOTIVE TEST CENTER (TIANJIN) CO., LTD., TIANJIN (CN)

(21) Appl. No.: 19/032,145

(22) Filed: Jan. 20, 2025

Related U.S. Application Data
(63) Continuation of application No. PCT/CN2025/070651, filed on Jan. 6, 2025.

(51) Int. Cl. G01M 17/007; G06F 30/20; G06F 119/06

(52) U.S. Cl. CPC G01M 17/007; G06F 30/20; G06F 2119/06

(57) ABSTRACT

The disclosure relates to the field of new energy vehicle testing, in particular to a virtual evaluation method and device for actual road energy consumption of new energy vehicles. The method includes: constructing an evaluation route according to cities used by a vehicle and typical routes of each of cities used by the vehicle; generating an actual road working condition library according to the evaluation route, months, weather conditions, road conditions and vehicle use periods; obtaining test data of the vehicle under each of working conditions; determining evaluation energy consumption according to the test data; determining a nominal energy consumption dispersion coefficient according to the evaluation energy consumption and a nominal energy consumption; determining an average comprehensive energy consumption according to the evaluation energy consumption; determining a vehicle energy consumption level according to the nominal energy consumption dispersion coefficient and the average comprehensive energy consumption.

### CROSS-REFERENCE TO RELATED APPLICATIONS

This application is a continuation of PCT/CN2025/070651, filed on Jan. 6, 2025, and claims priority of Chinese Patent Application No. 202411136455.6, filed on Aug. 19, 2024, the contents of which are hereby incorporated by reference.

### TECHNICAL FIELD

The disclosure relates to the field of new energy vehicle testing, in particular to a virtual evaluation method and device for actual road energy consumption of new energy vehicles.

### BACKGROUND

New energy vehicles have less pollutant emissions and high energy efficiency, which can effectively cope with the energy crisis and environmental pollution challenges faced by human development today, and are an important direction for the transformation and development of the vehicle industry. Under the guidance of the policies of various countries in the world, the new energy vehicle industry has developed rapidly, and its driving range, service life and safety have attracted more and more attention. At present, the driving range and energy consumption test of electric vehicles in our country are mainly carried out with reference to GB/T 18386, and the test is based on the rotating hub bench. However, the actual driving conditions are complex, the ambient and road factors are changeable, and different users and different region working conditions have led to great differences between the actual energy consumption and the announced energy consumption. Therefore, it is urgent to carry out energy efficiency evaluation research based on actual roads.

The traditional method based on the actual road data can reflect the real energy consumption level of vehicles, which is closer to the user's usage scenario. However, the road factors are changeable, and the test is time-consuming and costly, and it is difficult to expand on a large scale.

In view of this, the disclosure is provided.

### SUMMARY

The purpose of the disclosure is to provide a virtual evaluation method and device for vehicle actual road energy consumption, which can cover many cities and many vehicle use scenes without large-scale road test, and evaluate the actual road energy consumption efficiently and conveniently.

In order to achieve the above purpose, the disclosure adopts the following technical scheme.

In the first aspect, the disclosure provides a virtual evaluation method for actual road energy consumption of new energy vehicles, which includes:
constructing an evaluation route according to cities used by a vehicle and typical routes of each of cities used by the vehicle;
generating an actual road working condition library according to the evaluation route, months, weather conditions, road conditions and vehicle use periods;
obtaining test data of the vehicle under each of working conditions, where the test data is data obtained by simulating test with a vehicle model or testing with a real vehicle based on the actual road working condition library;
determining evaluation energy consumption according to the test data; where;
determining a nominal energy consumption dispersion coefficient according to the evaluation energy consumption and a nominal energy consumption;
determining an average comprehensive energy consumption according to the evaluation energy consumption;
determining a vehicle energy consumption level according to the nominal energy consumption dispersion coefficient and the average comprehensive energy consumption

As a further preferred technical scheme, the constructing an evaluation route according to cities used by a vehicle and typical routes of each of cities used by the vehicle includes:
determining cities used by the vehicle according to a new energy vehicle parc of each of cities, a temperature zone of each of cities, a geographical area of each of cities and a grade of each of cities;
determining the evaluation route according to typical road scenes, each driving route traffic flow, each driving route congestion situation and each driving route use frequency of cities used by the vehicle.

As a further preferred technical scheme, the months include July, January and April; the weather conditions include sunny days, rainy days and snowy days; the road conditions include: plains and hills; the vehicle use periods include: 7:00-9:00, 9:00-12:00, 13:00-16:00, 16:00-18:00 and 23:00-06:00.

As a further preferred technical scheme, determining evaluation energy consumption according to the test data, including:
calculating a correction sliding resistance according to the test data;
determining the evaluation energy consumption according to the correction sliding resistance.

As a further preferred technical scheme, calculating the correction sliding resistance according to the test data includes:
calculating the correction sliding resistance according to vehicle speeds, ambient temperatures, ambient pressure, included angles between vehicle driving directions and wind directions and a first correction factor in the test data;
where the first correction factor is used to characterize influence of weather conditions and road conditions on sliding resistance.

As a further preferred technical scheme, determining an average comprehensive energy consumption according to the evaluation energy consumption includes:
determining a first data set and a second data set according to the evaluation energy consumption; where the first data set is a data set formed by dividing the evaluation energy consumption by months, and the second data set is a data set formed by dividing the evaluation energy consumption by typical road scenes;
determining a first comprehensive energy consumption according to the first data set;
determining a second comprehensive energy consumption according to the second data set;
determining the average comprehensive energy consumption according to the first comprehensive energy consumption and the second comprehensive energy consumption.

As a further preferred technical scheme, determining a vehicle energy consumption level according to the nominal energy consumption dispersion coefficient and the average comprehensive energy consumption includes:
if the nominal energy consumption dispersion coefficient is less than value A, and the average comprehensive energy consumption is less than value I, the vehicle energy consumption level is determined to be excellent;
if the nominal energy consumption dispersion coefficient is greater than value B, or the average comprehensive energy consumption is greater than value II, the vehicle energy consumption level is determined to be poor; where, B>A, II>I; in other cases, the vehicle energy consumption level is determined to be good.

In the second aspect, the disclosure provides a virtual evaluation device for actual road energy consumption of new energy vehicles, including:
an evaluation route construction module, used for constructing an evaluation route according to cities used by a vehicle and typical routes of each of cities used by the vehicle;
an actual road working condition library generating module, used for generating an actual road working condition library according to the evaluation route, months, weather conditions, road conditions and vehicle use periods;
a test data obtaining module, used for obtaining test data of the vehicle under each of working conditions, where the test data is data obtained by simulating test with a vehicle model or testing with a real vehicle based on the actual road working condition library;
an evaluation energy consumption determining module, used for determining evaluation energy consumption according to the test data;
a nominal energy consumption dispersion coefficient determining module, used for determining the nominal energy consumption dispersion coefficient according to the evaluation energy consumption and a nominal energy consumption;
an average comprehensive energy consumption determining module, used for determining an average comprehensive energy consumption according to the evaluation energy consumption;
a vehicle energy consumption level determining module, used for determining a vehicle energy consumption level according to the nominal energy consumption dispersion coefficient and the average comprehensive energy consumption.

In a third aspect, the disclosure provides an electronic device, which includes:
at least one of processors, and a memory in communication connection with at least one of the processors;
where the memory stores instructions executable by at least one of the processors, and the instructions are executed by at least one of the processors to enable at least one of the processors to perform the above method.

In a fourth aspect, the disclosure provides a computer-readable storage medium, computer instructions are stored on the medium, and the computer instructions are used to enable a computer to execute the above method.

Compared with the prior art, the disclosure has the following beneficial effects.

The virtual evaluation method for the actual road energy consumption of new energy vehicles provided by the disclosure realizes the purpose of covering many cities and many vehicle use scenes without carrying out a large-scale road test through the processes of constructing an evaluation route, generating an actual road working condition library, obtaining test data, determining the evaluation energy consumption, determining the nominal energy consumption dispersion coefficient, determining the average comprehensive energy consumption, determining the vehicle energy consumption level and the like, and efficiently and conveniently carries out the actual road energy consumption evaluation. Moreover, this method determines the vehicle energy consumption level based on the evaluation energy consumption, the nominal energy consumption dispersion coefficient and the average comprehensive energy consumption. By introducing new energy consumption evaluation indicators, the actual energy consumption performance of vehicles can be more truly reflected, and the energy consumption evaluation is more accurate and reliable. In addition, this method is different from the traditional standard cycle working condition test and evaluation method, and establishes a multi-scene vehicle driving condition library to realize the energy consumption evaluation in real road environment, which is not limited by external ambient factors and saves the evaluation period and cost of real vehicles.

Further, the disclosure introduces a plurality of influencing factors in the real road environment to correct the sliding resistance of the vehicle, which can further improve the accuracy of the evaluation method and make it closer to the real vehicle.

### BRIEF DESCRIPTION OF THE DRAWINGS

In order to explain the specific embodiment of the disclosure or the technical scheme in the prior art more clearly, the drawings needed in the description of the specific embodiment or the prior art will be briefly introduced below. Obviously, the drawings in the following description are some embodiments of the disclosure, and other drawings can be obtained according to these drawings without creative work for ordinary skilled in the field.

FIG. 1 is a flow chart of a virtual evaluation method for actual road energy consumption of new energy vehicles provided by the disclosure;

FIG. 2 is a schematic diagram of the generation process of the actual road working condition library in the disclosure;

FIG. 3 is a schematic structural diagram of a virtual evaluation device for actual road energy consumption of new energy vehicles provided by the disclosure; and

FIG. 4 is a schematic structural diagram of an electronic device provided by the disclosure.

### DETAILED DESCRIPTION OF THE EMBODIMENTS

In the following, exemplary embodiments of the disclosure are described below with reference to the accompanying drawings, in which various details of the embodiments of the disclosure are included to facilitate understanding, and they should be considered as exemplary only. Therefore, those skilled in the art should realize that various changes and modifications can be made to the embodiments described herein without departing from the scope and spirit of the disclosure. Also, for the sake of clarity and conciseness, descriptions of well-known functions and structures are omitted in the following description.

### Embodiment 1

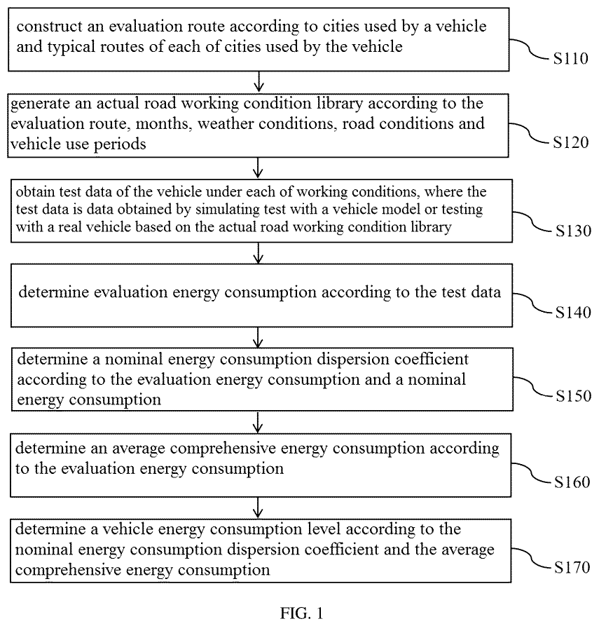

FIG. 1 is a flow chart of a virtual evaluation method for actual road energy consumption of new energy vehicles provided by this embodiment. This method can be executed by a virtual evaluation device for actual road energy consumption of new energy vehicles, which includes software and/or hardware, and is generally integrated in electronic device, which can be a computer. For convenience of understanding, the computer is the main body for each step in the method of this embodiment.

As shown in FIG. 1, this embodiment provides a virtual evaluation method for actual road energy consumption of new energy vehicles, which includes the following steps:

S110: an evaluation route is constructed according to cities used by a vehicle and typical routes of each of cities used by the vehicle.

Optionally, constructing an evaluation route according to cities used by a vehicle and typical routes of each of cities used by the vehicle includes:
cities used by the vehicle are determined according to a new energy vehicle parc of each of cities, a temperature zone of each of cities, a geographical area of each of cities and a grade of each of cities;
the evaluation route is determined according to typical road scenes, each driving route traffic flow, each driving route congestion situation and each driving route use frequency of cities used by the vehicle.

Further, the typical road scenes include urban routes, suburban routes, express routes and high-speed routes. When determining the evaluation route, the above-mentioned typical road scenes, each driving route traffic flow, each driving route congestion situation and each driving route use frequency are comprehensively considered.

S120: an actual road working condition library is generated according to the evaluation route, months, weather conditions, road conditions and vehicle use periods.

Optionally, the months include July, January and April; the weather conditions include sunny days, rainy days and snowy days; the road conditions include: plains and hills; the vehicle use periods include: 7:00-9:00, 9:00-12:00, 13:00-16:00, 16:00-18:00 and 23:00-06:00. The above months cover the highest, consistent and lowest months of the year, and several days can be selected in each month. The weather conditions should cover as many scenes as possible, and superimposed consideration is given to wind direction. The vehicle use periods cover various vehicle use periods such as morning peak, evening peak, leisure time and night.

Optionally, the months can also be August, January and October.

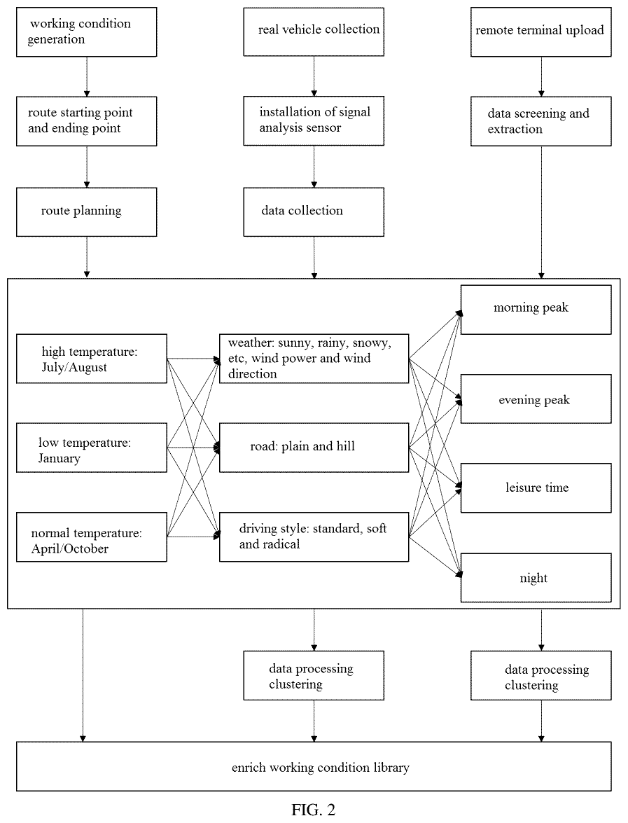

The above method can ensure that the actual road working condition library can cover the most application scenarios and make the evaluation results more perfect and reliable. When the above-mentioned actual road working condition library is generated by using the working condition generation algorithm, appropriate working condition segments can be inserted according to the information provided by the map, such as route driving distance, driving time, average vehicle speed, congestion situation, traffic situation, traffic light position and so on, and a working condition curve can be generated. In addition, the actual road working condition library can also be generated in a manner of road real vehicle collection. For example, test sensors, such as gradient sensors, ambient temperature sensors and speed sensors, can be installed on vehicles to obtain the real vehicle road working condition data under typical routes, and the working condition fragments can be obtained through cluster analysis, as shown in FIG. 2.

S130: test data of the vehicle under each of working conditions is obtained, where the test data is data obtained by simulating test with a vehicle model or testing with a real vehicle based on the actual road working condition library.

In the actual test, the vehicle model can be used for simulation test or the real vehicle can be used for test.

Vehicle model: the vehicle model is built according to composition architecture, control strategy and model parameters of the vehicle, which includes vehicle power system one-dimensional simulation modeling and the thermal management system integrated model. The thermal management system integrated model includes air conditioning system one-dimensional simulation modeling, passenger compartment one-dimensional simulation modeling, one-dimensional simulation modeling of power battery thermal management system, one-dimensional simulation modeling of motor electric control cooling system, and control system modeling. According to the energy transmission relationship among models, the interaction between data signals is carried out to ensure the accuracy of the model and verify the accuracy of the model. The actual road working condition library generated in S130 is introduced into the model for simulation, and a large number of simulation data are obtained to evaluate the energy results.

Where, when verifying the accuracy of the model, the following formula can be used:

$$MAPE = \frac{100 \%}{N} {\sum }_{i = 1}^{N} \vert \frac{{\overline{y}}_{i}^{*} - {y}_{i}}{{y}_{i}} \vert ,$$

where: MAPE is the deviation between simulation and test index; y̅₁* is the simulation value; y₁ is the test value; N is the total number of samples for all evaluation energy consumption. When MAPE<5%, the accuracy of the model is considered to meet the requirements.

S140: evaluation energy consumption is determined according to the test data.

Optionally, determining evaluation energy consumption according to the test data includes:
a correction sliding resistance is calculated according to the test data;
the evaluation energy consumption is determined according to the correction sliding resistance.

Optionally, calculating the correction sliding resistance according to the test data includes:
the correction sliding resistance is calculated according to vehicle speeds, ambient temperatures, ambient pressure, included angles between vehicle driving directions and wind directions and a first correction factor in the test data;
the first correction factor is used to characterize influence of weather conditions and road conditions on sliding resistance.

For automobile power system, the main part of energy consumption is the energy consumed by overcoming driving resistance, and the resistance expression is usually measured by sliding test fitting. Sliding test can monitor tire rolling resistance, air resistance, drivetrain resistance, etc. Constant term is generally regarded as tire rolling resistance, first term is drivetrain resistance, and quadratic term is air resistance. The sliding test requires the road to be flat, clean, dry and windless, so it is necessary to optimize the sliding resistance in the real road environment. The ambient factors that affect the correction are temperature, humidity, air pressure and longitudinal wind speed.

$${F}_{reference} = A + B \cdot V + C \cdot {V}^{2} = [ ( {f}_{0} - {w}_{1} - {K}_{1} ) + {f}_{1} v ] \times [ 1 + {K}_{0} ( T - 20 ) ] + {K}_{2} {f}_{2} {v}^{2} ;$$

$${F}_{correction} = ( \frac{A}{1 + {K}_{0} ( T - 20 )} + {w}_{1} ) \cdot \partial + \frac{B}{1 + {K}_{0} ( T - 20 )} \cdot V + \frac{c}{{K}_{2}} {( V - {V}_{a} cos θ )}^{2} ;$$

$${w}_{1} = {3.6}^{2} \times {f}_{2} \times {V}_{a}^{2} ;$$

$${K}_{0} = 8.6 \times {10}^{- 3} {K}^{- 1} ;$$

$${K}_{2} = \frac{T}{293} \times \frac{100}{P} ;$$

where: F_{reference} is the sliding resistance in a reference state, N;
F_{correction} is the correction sliding resistance obtained by considering real ambient factors, N;
V is the vehicle speed, km/h;
A is the constant term coefficient in a reference state, N;
B is the first term coefficient in a reference state, N/(km/h);
C is quadratic term coefficient in a reference state, N/(km/h)²;
f₀ is constant term coefficient in real road environment, N;
f₁ is first term coefficient in real road environment, N/(km/h);
f₂ is quadratic term coefficient in real road environment, N/(km/h)²;
K₀ is the rolling resistance correction factor, K−1;
T is the ambient temperature, ° C.;
p is the ambient pressure, kPa;
w₁ is the wind resistance correction value, N;
∂ is the first correction factor;
K₂ is the air resistance correction factor;
Vₐ is the wind speed, km/h;
θ is the included angle between the driving direction of the vehicle and the wind direction, °,

The first correction factor d is shown in the following table:

road type

| weather condition | 1-asphalt | 2-concrete | 3-dirt road |
|---|---|---|---|
| 1-drying | δ₁₁ | δ₁₂ | δ₁₃ |
| 2-raining | δ₂₁ | δ₂₂ | δ₂₃ |
| 3-ice and snow | δ₃₁ | δ₃₂ | δ₃₃ |

Optionally, the evaluation energy consumption Eᵢ is calculated by the following formula:

$${E}_{i} = \frac{{\int }_{0}^{t} [ ( {F}_{correction} + {F}_{acceleration} ) {v}_{i} + {P}_{accessory} ] dt}{{\int }_{0}^{t} {v}_{i} dt} \times \frac{1}{36} ;$$

$${F}_{acceleration} = m {a}_{i} ;$$

$${a}_{i} = \frac{{V}_{i + 1} - {V}_{i - 1}}{2 Δ t} ;$$

where: Vᵢ is a vehicle speed at time i, m/s;
Vᵢ₊₁ is a vehicle speed at time i+1, m/s;
Vᵢ₋₁ is a vehicle speed at time i−1, m/s;
P_{accessory} is accessory power, including air conditioning, low-voltage accessories, etc., W;
m is vehicle mass, kg;
aᵢ is an acceleration at time i, m/s²;
Δt is sampling time interval, s.

S150: a nominal energy consumption dispersion coefficient is determined according to the evaluation energy consumption and a nominal energy consumption.

The virtual evaluation method of energy consumption mentioned in this embodiment involves a large number of energy consumption data, and it is necessary to evaluate the big data results more accurately and reliably. Both temperature and route working conditions have significant effects on energy consumption, so a comprehensive evaluation of energy consumption for different seasons and routes is proposed, and adopting a nominal energy consumption dispersion coefficient is proposed to reflect the fluctuation degree of energy consumption.

Nominal energy consumption dispersion coefficient λ: the dispersion degree of the evaluation energy consumption Eᵢ relative to the nominal energy consumption E is reflected, and the smaller the dispersion degree, the smaller the fluctuation of vehicle energy consumption under different environment and road conditions, and the better the vehicle performance. On the contrary, it is poor.

$$λ = \frac{\sqrt{\frac{{\sum }_{i - 1}^{N} {( {E}_{i} - E )}^{2}}{N}}}{E} ;$$

where N is the total number of samples for all evaluation energy consumption.

S160: an average comprehensive energy consumption is determined according to the evaluation energy consumption.

Optionally, determining an average comprehensive energy consumption according to the evaluation energy consumption includes:
a first data set and a second data set are determined according to the evaluation energy consumption; where the first data set is a data set formed by dividing the evaluation energy consumption by months, and the second data set is a data set formed by dividing the evaluation energy consumption by typical road scenes;
a first comprehensive energy consumption is determined according to the first data set;
a second comprehensive energy consumption is determined according to the second data set;
the average comprehensive energy consumption is determined according to the first comprehensive energy consumption and the second comprehensive energy consumption.

Where, the first data set can mainly reflect the influence of temperature on evaluation energy consumption, so the energy consumption in high temperature season, low temperature season and normal temperature season in a year can be comprehensively evaluated by using the first data set, and the calculation method is as follows:

| first comprehensive | | | | |
|---|---|---|---|---|
| energy consumption | high | low | normal | first comprehensive |
| evaluation index | temperature | temperature | temperature | energy consumption |
| evaluation energy | E₁ | E₂ | E | EC₁ = E₁γ₁ + |
| consumption | | | | E₂γ₂ + E₃γ₃ |
| time proportion | γ₁ | γ₂ | γ₃ | |

The second data set can mainly reflect the influence of different driving routes on the evaluation energy consumption, so the energy consumption of urban routes, express routes and high-speed routes is comprehensively evaluated, and the calculation method is as follows:

| second comprehensive | | | | | |
|---|---|---|---|---|---|
| energy consumption | urban | suburban | express | high-speed | second comprehensive |
| evaluation index | route | route | route | route | energy consumption |
| evaluation energy | Eₐ | E_{b} | E_{c} | E_{d} | EC₂ = Eₐγₐ + E_{b}γ_{b} + |
| consumption | | | | | E_{c}γ_{c} + E_{d}γ_{d} |
| time proportion | γₐ | γ_{b} | γ_{c} | γ_{d} | |

The above EC₁ is the first comprehensive energy consumption, and the above EC₂ is the second comprehensive energy consumption.

An average comprehensive energy consumption E̅C̅ is calculated according to the first comprehensive energy consumption and the second comprehensive energy consumption:

$$\overline{EC} = \frac{( {E}_{1} + {E}_{2} )}{2} .$$

It should be understood that the above nominal energy consumption dispersion coefficient, the first comprehensive energy consumption, the second comprehensive energy consumption and the average comprehensive energy consumption are the results obtained by considering all the working conditions in all cities, rather than the test results of a certain working condition in a certain city.

S170: a vehicle energy consumption level is determined according to the nominal energy consumption dispersion coefficient and the average comprehensive energy consumption.

Optionally, determining a vehicle energy consumption level according to the nominal energy consumption dispersion coefficient and the average comprehensive energy consumption includes:
if the nominal energy consumption dispersion coefficient is less than value A, and the average comprehensive energy consumption is less than value I, the vehicle energy consumption level is determined to be excellent;
if the nominal energy consumption dispersion coefficient is greater than value B, or the average comprehensive energy consumption is greater than value II, the vehicle energy consumption level is determined to be poor; where, B>A, II>I;
in other cases, the vehicle energy consumption level is determined to be good.

Specifically, the following table can be used to determine the vehicle energy consumption level:

E̅C̅

| λ | 0 | I | II | III | . . . |
|---|---|---|---|---|---|
| 0 | excellent | excellent | good | poor | poor |
| A | excellent | excellent | good | poor | poor |
| B | good | good | good | poor | poor |
| C | poor | poor | poor | poor | poor |
| . . . | poor | poor | poor | poor | poor |

The above virtual evaluation method for the actual road energy consumption of new energy vehicles realizes the purpose of covering many cities and many vehicle use scenes without carrying out a large-scale road test through the processes of constructing an evaluation route, generating an actual road working condition library, obtaining test data, determining the evaluation energy consumption, determining the nominal energy consumption dispersion coefficient, determining the average comprehensive energy consumption, determining the vehicle energy consumption level and the like, and efficiently and conveniently carries out the actual road energy consumption evaluation. Moreover, this method determines the vehicle energy consumption level based on the evaluation energy consumption, the nominal energy consumption dispersion coefficient and the average comprehensive energy consumption. By introducing new energy consumption evaluation indicators, the actual energy consumption performance of vehicles can be more truly reflected, and the energy consumption evaluation is more accurate and reliable. In addition, this method is different from the traditional standard cycle working condition test and evaluation method, and establishes a multi-scene vehicle driving condition library to realize the energy consumption evaluation in real road environment, which is not limited by external ambient factors and saves the evaluation period and cost of real vehicles.

Further, the disclosure introduces a plurality of influencing factors in the real road environment to correct the sliding resistance of the vehicle, which can further improve the accuracy of the evaluation method and make it closer to the real vehicle.

### Embodiment 2

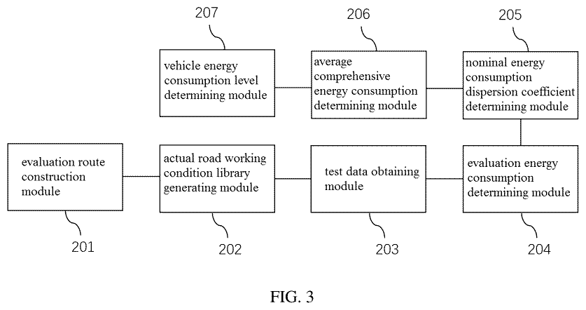

As shown in FIG. 3, this embodiment provides a virtual evaluation device for actual road energy consumption of new energy vehicles, including:
an evaluation route construction module 201, used for constructing an evaluation route according to cities used by a vehicle and typical routes of each of cities used by the vehicle;
an actual road working condition library generating module 202, used for generating an actual road working condition library according to the evaluation route, months, weather conditions, road conditions and vehicle use periods;
a test data obtaining module 203, used for obtaining test data of the vehicle under each of working conditions, where the test data is data obtained by simulating test with a vehicle model or testing with a real vehicle based on the actual road working condition library;
an evaluation energy consumption determining module 204, used for determining evaluation energy consumption according to the test data;
a nominal energy consumption dispersion coefficient determining module 205, used for determining the nominal energy consumption dispersion coefficient according to the evaluation energy consumption and a nominal energy consumption;
an average comprehensive energy consumption determining module 206, used for determining an average comprehensive energy consumption according to the evaluation energy consumption;
a vehicle energy consumption level determining module 207, used for determining a vehicle energy consumption level according to the nominal energy consumption dispersion coefficient and the average comprehensive energy consumption.

The device is used for executing the above-mentioned method, so it has at least functional modules and beneficial effects corresponding to the above-mentioned method.

### Embodiment 3

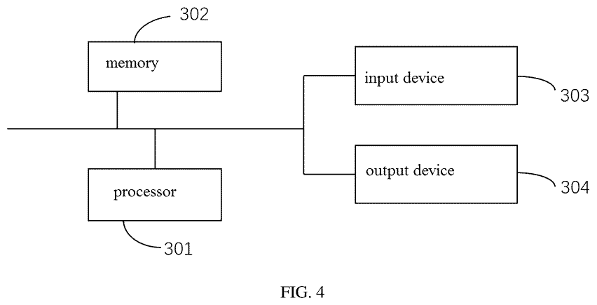

As shown in FIG. 4, this embodiment provides an electronic device, including:
at least one of processors, and
a memory in communication connection with at least one of the processors; where,
the memory stores instructions executable by at least one of the processors, and the instructions are executed by at least one of the processors to enable at least one of the processors to perform the above method. At least one of the processors in the electronic device can execute the above-mentioned method, thus having at least the same advantages as the above-mentioned method.

Optionally, the electronic device also includes interfaces for connecting various components, including high-speed interfaces and low-speed interfaces. The various components are interconnected by different buses, and can be installed on a common motherboard or in other ways as needed. The processor may process instructions executed in an electronic device, including instructions stored in or on a memory to display graphical information of a GUI (Graphical User Interface) on an external input/output device, such as a display device coupled to an interface. In other embodiments, multiple processors can be used with multiple memories, and/or multiple buses can be used with multiple memories, if necessary. Similarly, multiple electronic devices can be connected (for example, as a server array, a group of blade servers, or a multiprocessor system), and each device provides some necessary operations. In FIG. 4, a processor 301 is taken as an example.

As a computer-readable storage medium, the memory 302 can be used to store software programs, computer-executable programs and modules, such as program instructions/modules corresponding to the virtual evaluation method of actual road energy consumption of new energy vehicles in the embodiment of the disclosure (for example, evaluation route construction module, actual road working condition library generation module, test data obtaining module, evaluation energy consumption determination module, nominal energy consumption dispersion coefficient determination module, average comprehensive energy consumption determination module and vehicle energy consumption level determination module in the virtual evaluation device for actual road energy consumption of new energy vehicles). The processor 301 executes various functional applications and data processing of the device by running software programs, instructions and modules stored in the memory 302, that is, the virtual evaluation method of actual road energy consumption of new energy vehicles described above is realized.

The memory 302 may mainly include a storage program area and a storage data area, where the storage program area may store an operating system and an application program required by at least one function. The storage data area can store data created according to the use of the terminal and the like. In addition, the memory 302 may include high-speed random access memory, and may also include non-volatile memory, such as at least one disk memory apparatus, flash memory apparatus, or other non-volatile solid-state memory apparatus. In some examples, the memory 302 may further include memories remotely located with respect to the processor 301, and these remote memories may be connected to devices through a network. Examples of the above networks include, but are not limited to, the Internet, an enterprise intranet, a local area network, a mobile communication network, and combinations thereof.

The electronic device may further include an input device 303 and an output device 304. The processor 301, the memory 302, the input device 303 and the output device 304 can be connected by a bus or other means. In FIG. 4, the connection through the bus is taken as an example.

The input device 303 may receive input digital or character information, and the output device 304 may include a display device, an auxiliary lighting device (for example, an LED), a tactile feedback device (for example, a vibration motor), and the like. The display device may include, but is not limited to, a liquid crystal display (LCD), a light emitting diode (LED) display and a plasma display. In some embodiments, the display device may be a touch screen.

### Embodiment 4

This embodiment provides a computer-readable storage medium, computer instructions are stored on the medium, and the computer instructions are used to make a computer execute the above method. The computer instructions on the computer-readable storage medium are used to make a computer execute the above-mentioned method, thus having at least the same advantages as the above-mentioned method.

The medium in the disclosure can be any combination of one or more computer-readable medium. The medium may be a computer-readable signal medium or a computer-readable storage medium. The medium can be, for example, but not limited to, an electrical, magnetic, optical, electromagnetic, infrared, or semiconductor system, device or apparatus, or a combination of any of the above. More specific examples of medium (a non-exhaustive list) include: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage apparatus, a magnetic storage apparatus, or any suitable combination of the above. In this document, a medium can be any tangible medium containing or storing a program, which can be used by or in combination with an instruction execution system, device or apparatus.

A computer-readable signal medium may include a data signal propagated in baseband or as part of a carrier wave, in which computer-readable program code is carried. This propagated data signal can take many forms, including but not limited to electromagnetic signals, optical signals or any suitable combination of the above. The computer-readable signal medium can also be any computer-readable medium other than the computer-readable storage medium, which can send, propagate or transmit the program for use by or in connection with the instruction execution system, device or apparatus.

The program code contained in the computer-readable medium can be transmitted by any suitable medium, including but not limited to wireless, wire, optical cable, RF (Radio Frequency) and the like, or any suitable combination of the above.

Computer program codes for performing the operations of the disclosure can be written in one or more programming languages or their combinations, programming languages includes object-oriented programming languages such as Java, Smalltalk, C++, and also includes conventional procedural programming languages such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

It should be understood that steps can be reordered, added or deleted using the various forms of workflow shown above. For example, the steps described in this disclosure can be executed in parallel, can also be executed sequentially or can also be executed in a different order, so long as the desired results of the technical scheme disclosed in this disclosure can be achieved, there is no restriction here.

The above specific embodiments do not limit the protection scope of this disclosure. It should be understood by those skilled in the art that various modifications, combinations, subcombinations and substitutions can be made according to design requirements and other factors. Any modification, equivalent substitution and improvement made within the spirit and principle of this disclosure should be included in the protection scope of this disclosure.

What is claimed is:

1. A virtual evaluation method for actual road energy consumption of new energy vehicles, comprising:
constructing an evaluation route according to cities used by a vehicle and typical routes of each of cities used by the vehicle;
generating an actual road working condition library according to the evaluation route, months, weather conditions, road conditions and vehicle use periods;
obtaining test data of the vehicle under each of working conditions, wherein the test data is data obtained by simulating test with a vehicle model or testing with a real vehicle based on the actual road working condition library;
determining evaluation energy consumption according to the test data, comprising: calculating a correction sliding resistance according to the test data; determining the evaluation energy consumption according to the correction sliding resistance; wherein calculating the correction sliding resistance according to the test data comprises: calculating the correction sliding resistance according to vehicle speeds, ambient temperatures, ambient pressure, included angles between vehicle driving directions and wind directions and a first correction factor in the test data; wherein the first correction factor is used to characterize influence of weather conditions and road conditions on sliding resistance;
determining a nominal energy consumption dispersion coefficient according to the evaluation energy consumption and a nominal energy consumption;
determining an average comprehensive energy consumption according to the evaluation energy consumption;
determining a vehicle energy consumption level according to the nominal energy consumption dispersion coefficient and the average comprehensive energy consumption.

2. The virtual evaluation method for actual road energy consumption of new energy vehicles according to claim 1, wherein the constructing an evaluation route according to cities used by a vehicle and typical routes of each of cities used by the vehicle comprises:
determining cities used by the vehicle according to a new energy vehicle parc of each of cities, a temperature zone of each of cities, a geographical area of each of cities and a grade of each of cities;
determining the evaluation route according to typical road scenes, each driving route traffic flow, each driving route congestion situation and each driving route use frequency of cities used by the vehicle.

3. The virtual evaluation method for actual road energy consumption of new energy vehicles according to claim 1, wherein the months comprise July, January and April; the weather conditions comprise sunny days, rainy days and snowy days; the road conditions comprise: plains and hills; the vehicle use periods comprise: 7:00-9:00, 9:00-12:00, 13:00-16:00, 16:00-18:00 and 23:00-06:00.

4. The virtual evaluation method for actual road energy consumption of new energy vehicles according to claim 1, wherein determining an average comprehensive energy consumption according to the evaluation energy consumption comprises:
determining a first data set and a second data set according to the evaluation energy consumption; wherein the first data set is a data set formed by dividing the evaluation energy consumption by months, and the second data set is a data set formed by dividing the evaluation energy consumption by typical road scenes;
determining a first comprehensive energy consumption according to the first data set;
determining a second comprehensive energy consumption according to the second data set;
determining the average comprehensive energy consumption according to the first comprehensive energy consumption and the second comprehensive energy consumption.

5. The virtual evaluation method for actual road energy consumption of new energy vehicles according to claim 1, wherein determining a vehicle energy consumption level according to the nominal energy consumption dispersion coefficient and the average comprehensive energy consumption comprises:
if the nominal energy consumption dispersion coefficient is less than value A, and the average comprehensive energy consumption is less than value I, the vehicle energy consumption level is determined to be excellent;
if the nominal energy consumption dispersion coefficient is greater than value B, or the average comprehensive energy consumption is greater than value II, the vehicle energy consumption level is determined to be poor; wherein, B>A, II>I;
in other cases, the vehicle energy consumption level is determined to be good.

6. A virtual evaluation device for actual road energy consumption of new energy vehicles, comprising:
an evaluation route construction module, used for constructing an evaluation route according to cities used by a vehicle and typical routes of each of cities used by the vehicle;
an actual road working condition library generating module, used for generating an actual road working condition library according to the evaluation route, months, weather conditions, road conditions and vehicle use periods;
a test data obtaining module, used for obtaining test data of the vehicle under each of working conditions, wherein the test data is data obtained by simulating test with a vehicle model or testing with a real vehicle based on the actual road working condition library;
an evaluation energy consumption determining module, used for determining evaluation energy consumption according to the test data, and comprising: a correction sliding resistance is calculated according to the test data; the evaluation energy consumption is determined according to the correction sliding resistance; wherein calculating the correction sliding resistance according to the test data comprises: the correction sliding resistance is calculated according to vehicle speeds, ambient temperatures, ambient pressure, included angles between vehicle driving directions and wind directions and a first correction factor in the test data; wherein the first correction factor is used to characterize influence of weather conditions and road conditions on sliding resistance;
a nominal energy consumption dispersion coefficient determining module, used for determining the nominal energy consumption dispersion coefficient according to the evaluation energy consumption and a nominal energy consumption;
an average comprehensive energy consumption determining module, used for determining an average comprehensive energy consumption according to the evaluation energy consumption;
a vehicle energy consumption level determining module, used for determining a vehicle energy consumption level according to the nominal energy consumption dispersion coefficient and the average comprehensive energy consumption.

7. An electronic device, comprising:
at least one of processors, and a memory in communication connection with at least one of the processors;
wherein the memory stores instructions executable by at least one of the processors, and the instructions are executed by at least one of the processors to enable at least one of the processors to perform the method of claim 1.
